(19) United States
(12) Patent Application Publication
(10) Pub. No.: US 2018/0317502 A1
(43) Pub. Date: Nov. 8, 2018

(54) GLUTEN-FREE BISCUITS COMPRISING BRASSICACEAE SEED PROTEIN

(71) Applicant: NESTEC S.A., Vevey (CH)

(72) Inventors: Koraljka Rade-Kukic, Lafayette, CA (US); Luis Roberto King, Pully (CH); Hugo Gloria-Hernandez, Vina del Mar (CL)

(21) Appl. No.: 15/772,424

(22) PCT Filed: Oct. 31, 2016
(86) PCT No.: PCT/EP2016/076245

§ 371 Date: Apr. 30, 2018

(30) Foreign Application Priority Data
Nov. 5, 2015 (EP) 15193138.3

(51) Int. Cl. A21D 13/066; A21D 2/26; A21D 10/02; A21D 2/18; A21D 13/80

(52) U.S. Cl. CPC A21D 13/066; A21D 2/266; A21D 13/80; A21D 10/02; A21D 2/186; A21D 2/265

(57) ABSTRACT

The present invention generally relates to gluten-free food products. In particular, the present invention concerns gluten-free biscuits comprising a starch-containing material and Brassicaceae seed protein. Further aspects of the invention are a gluten-free biscuit dough and a process for manufacturing a gluten-free biscuit.

### FIELD OF THE INVENTION

The present invention generally relates to gluten-free food products. In particular, the present invention concerns gluten-free biscuits comprising a starch-containing material and Brassicaceae seed protein. Further aspects of the invention are a gluten-free biscuit dough and a process for manufacturing a gluten-free biscuit.

### BACKGROUND OF THE INVENTION

Coeliac disease is a chronic inflammatory disorder of the small bowel induced in genetically susceptible people by the irritant gluten and possibly other environmental cofactors. [A. Di Sabatino et al., The Lancet, 373, 1480-1493 (2009)]. Coeliac disease is the most common lifelong dietary disorder worldwide, affecting around 1% of the European population and claimed to be “highly under-diagnosed in all countries” [K. Mustalahti et al., Annals of Medicine, 42, 587-595 (2010)]. A strict gluten-free diet remains the mainstay of safe and effective treatment. Gluten is a protein composite found in foods processed from wheat and related grain species, including barley and rye. In addition to suffers from coeliac disease, people who are gluten-intolerant or gluten sensitive are sometimes recommended or prescribed to follow a gluten-free diet. These may include people with Crohn's disease, ulcerative colitis, irritable bowel syndrome, dermatitis herpetiformis, or autism.

Replacing wheat flour in bakery products is a difficult challenge. The baking industry in most parts of the world is based on the unique properties of wheat flour, and manufacturing processes have been optimized around these properties. Furthermore, the desirable textures and flavours of bakery products have been built around wheat flour, with gluten playing a key role in determining the baking quality.

The principal structure-forming ingredient used in conventional biscuit doughs is wheat flour. Very few biscuits are made without any wheat flour and those are usually atypical in organoleptic characteristics [Wiley Encyclopedia of Food Science and Technology, 2^{nd} Edition, Vol 1, p 183, 2000]. In biscuits, gluten confers absorption capacity, cohesiveness, viscosity and elasticity to the dough. Gluten plays a critical role in the development of particular biscuit characteristics such as spread during baking, as well as providing resistance to breakage in the final biscuit. Elimination of gluten from the flour base leads to serious defects in processing and texture properties, including dryness, lack of elasticity, and lack of cohesiveness.

In an attempt to provide gluten-free biscuits with similar properties to gluten-containing biscuits, structure-building additives have been proposed. US20110045146 proposes the use of additives such as xanthan gum and guar gum in a ready to bake cookie dough. These materials are hydrophilic and thus may require excessive amounts of water. During baking, the high water content leads to more fully pasted starch and in turn a more brittle, crumbly final texture. Replacing gluten with non-protein materials may also result in a product with a lower nutritional value.

Milk proteins, surimi proteins, soya proteins and egg proteins have all been proposed in gluten-free bakery products [A. Houben et al., Eur. Food Res. Technol, 235, 195-208 (2012)]. However, these proteins may be responsible for allergic reactions in some people and may lead to an undesirable taste, especially when used at high levels.

Hence, there remains a need to provide gluten-free biscuits which match the properties of wheat biscuits more closely, provide good nutrition and contain ingredients which are attractive to the consumer. In addition, ingredients used to replace gluten should be relatively inexpensive and provide the desired functionality at a low level of addition so as to allow gluten-free biscuit to be manufactured at a low cost. Ideally, gluten-free biscuit formulations should be capable of being produced on standard biscuit production equipment, with similar processing times.

Several species of Brassicaceae or Cruciferae have become important agricultural crops around the world. Among these, canola or rapeseed (Brassica napus and Brassica rapa, formerly Brassica campestris), oriental and brown mustard (Brassica juncea), black mustard (Brassica nigra) and yellow mustard (Sinapis alba synonym Brassica hirta) are important in the global oilseed economy [J. P. D. Wanasundara, Critical Reviews in Food Science and Nutrition, 51, 635-677 (2011)]. A major commercial use of Brassicaceae seeds is the production of edible oils, but at present Brassicaceae seed proteins are primarily used for feeding livestock.

The nutritional quality of wheat protein is low in certain amino acids such as lysine. U.S. Pat. No. 8,535,907 describes the using canola protein concentrate to improve the nutritional content of foods including biscuits.

WO03/075673 describes using canola protein isolate to replace egg and milk proteins for their fat binding properties, for example in cookie mixes. It does not suggest that canola protein isolate might be able to replace the functionality of gluten and so provide a gluten-free biscuit.

An object of the present invention is to improve the state of the art and to provide an improved gluten-free biscuit to overcome at least some of the inconveniences described above, or at least to provide a useful alternative. The object of the present invention is achieved by the subject matter of the independent claims. The dependent claims further develop the idea of the present invention.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”.

The present invention provides in a first aspect a gluten-free biscuit comprising between 0.5 and 15 wt. % Brassicaceae seed protein on a dry basis and a gluten-free starch-containing material having a particle size distribution D90 less than 3.000 μm. In a second aspect, the invention relates to a process for manufacturing a gluten-free biscuit comprising preparing a gluten-free dough comprising between 4 to 30 wt. % water and, on a dry basis, 0.5 to 10 wt. % Brassicaceae seed protein, 15 to 75 wt. % starch, 1 to 40 wt. % sweetener and 0 to 40 wt. % oil and/or fat and cooking the dough, wherein the starch has a particle size distribution D90 less than 1000 μm or is comprised within a starch-containing material having a particle size distribution D90 less than 1000 μm. A further aspect of the invention is a gluten-free biscuit dough for making gluten-free biscuits, the dough comprising between 4 and 30 wt. % water and, on a dry basis, 0.5 to 10 wt. % Brassicaceae seed protein, 15 to 75 wt. % starch, 1 to 40 wt. % sweetener and 0 to 40 wt. % oil and/or fat, wherein the starch has a particle size distribution D90 less than 1000 μm or is comprised within a starch-containing material having a particle size distribution D90 less than 1000 μm.

The inventors surprisingly found that by using Brassicaceae seed protein in gluten-free biscuit they can obtain a biscuit having processing and final product characteristics approaching that of gluten-containing biscuits, and better than some commercially available gluten-free biscuits and biscuit mixes/doughs. In particular, Brassicaceae seed protein permits the creation of a biscuit dough with good spread during baking and forms a biscuit with good resistance to breaking.

### BRIEF DESCRIPTION OF THE FIGURES

FIG. 1 is a photograph of the biscuit moulder used for formatting gluten-free biscuits.

FIG. 2 shows different doughs used for manufacturing gluten-free biscuits; A—corn starch, B—corn flour, C—rice flour, D—potato starch, E—corn flour+corn starch+5% Canola protein, F—corn flour+5% Canola protein, G—rice flour+potato starch+5% Canola protein, H—potato starch+10% Canola protein.

FIG. 3 shows control gluten-free biscuits without canola after baking; Ref—wheat flour, C—rice flour, B—corn flour, A—corn starch and D—potato starch.

FIG. 4 shows gluten-free biscuits after baking; Ref—wheat flour, RF—rice flour, CF Corn flour, PS—potato starch, CS—corn starch with 5% canola protein (5% CP) and 10% canola protein (10% CP).

FIG. 5 shows gluten-free biscuits after baking; E—corn flour+corn starch+5% Canola protein and G—rice flour+potato starch+5% Canola protein.

FIG. 6 shows gluten-free doughs before baking; G—rice flour+potato starch+5% Canola protein, E—corn flour+corn starch+5% Canola protein, B—corn flour, F—corn flour+5% Canola protein and I—potato starch+5% Canola protein.

FIG. 7 shows the gluten-free biscuits baked from the doughs in FIG. 6.

FIG. 8 is a plot of force (Newtons) against strain (mm) during a three-point bending test for a gluten-free biscuit without canola protein (J).

FIG. 9 is a plot of force (Newtons) against strain (mm) during a three-point bending test for a gluten-free biscuit with canola protein (K).

FIG. 10 is a plot of the maximum force (Newtons) versus the strain at that maximum force (mm) for biscuits L (♦), M (), N (▴) and O (●).

FIG. 11 is a plot of the visco-elastic modulus (N/mm) versus the strain at maximum force (mm) for biscuits L (♦), M (), N (▴) and O (●).

FIG. 12 shows photographs of biscuits L, M, N and O after the three-point bend test.

FIG. 13 is a photograph of ready-to-bake dough before baking FIG. 14 is a photograph of a biscuit baked from the ready-to-bake dough.

### DETAILED DESCRIPTION OF THE INVENTION

Consequently the present invention relates in part to a gluten-free biscuit comprising between 0.5 and 15 wt. % Brassicaceae seed protein on a dry basis and a gluten-free starch-containing material having a particle size distribution D90 less than 1000 μm (for example less than 300 μm). The term gluten-free in the current specification refers to products with less than 20 ppm gluten, which is in accordance with the definition from Codex Alimentarius Standard 118-1979. The starch-containing material may be starch itself, or it may for example be a non-gluten flour comprising starch such as rice flour. Starch-containing material having a particle size distribution D90 less than 1000 μm is able to form the basis of the dough and final biscuit structure, as opposed to discrete larger pieces of starch-containing material such as rolled oats which may be used to provide textural contrast and flavour as inclusions within the main structure of the biscuit. The D90 value is a common method of describing a particle size distribution. The D90 is the diameter where 90% of the mass of the particles in the sample have a diameter below that value. The D90 value may be measured for example by a laser light scattering particle size analyser. The gluten-free starch-containing material in the gluten-free biscuit of the present invention may for example have a particle size distribution D90 of between 10 and 1000 μm, for example it may have a particle size distribution D90 of between 15 and 300 μm.

The term biscuit in the current specification is used in the British English sense, it includes crackers and sweet biscuits (referred to in American English as cookies).

Removal of gluten from biscuit formulations in turn reduces the protein content and therefore the nutritional value of the biscuit. Using Brassicaceae seed protein as a gluten replacement, rather than for example gums and emulsifiers, provides a more nutritious gluten-free biscuit. As Brassicaceae seeds are generally grown for their oil, Brassicaceae seeds may provide an inexpensive source of protein as a by-product of oil production. It is therefore advantageous to be able to use Brassicaceae seed protein to manufacture gluten-free biscuit. In addition, acceptable biscuits can be obtained using low levels of Brassicaceae seed protein which may reduce the cost still further compared to other gluten substitute proteins. The gluten-free biscuit may comprise between 0.5 and 10 wt. % Brassicaceae seed protein on a dry basis, for example between 1 and 5 wt. % Brassicaceae seed protein on a dry basis.

The main component of traditional biscuits is starch. In a traditional wheat-based biscuit the starch is contained in wheat flour and it is the formation of a gluten-starch matrix which provides the desirable texture of biscuits. Other typical biscuit ingredients are oils and fats, sweeteners and leavening agents such as chemical leaveners or yeast. Many traditional biscuits are baked products whose structure is created by the combination of wheat flour, fat and sugar. The gluten-free biscuit of the invention may comprise on a dry basis 0.5 to 10 wt. % Brassicaceae seed protein, 15 to 75 wt. % starch (for example 20 to 50% starch), 0 to 40 wt. % sweetener (for example 15 to 40 wt. % sweetener) and 0 to 40 wt. % oil and/or fat (for example 10 to 40 wt. % oil and/or fat). All sweet biscuits and many crackers contain some form of sweetener. The most common sweetener in traditional biscuits is sucrose, which functions as a nutritive sweetener, texturizer, colouring agent and means of controlling spread during baking. Other nutritive sweeteners may be used such as invert syrup, honey and hydrolysed corn starch (e.g. confectioner's glucose syrup). Synthetic sweeteners such as saccharin and aspartame can be used in certain dietetic sweet biscuits, however these do not provide the same bulking effect as sucrose.

The oil may be, for example, a vegetable oil such as sunflower oil or olive oil. The fat may be for example butter or margarine. The gluten-free biscuit of the current invention may also contain other ingredients such as dried fruit, chocolate chips, nuts or seeds.

The term starch is used in the conventional manner to refer to a carbohydrate consisting of a large number of glucose units joined by glycosidic bonds. Starch does not contain gluten. The starch-containing material comprised within the gluten-free biscuit of the invention may be gluten-free ground cereals, pulses, roots or mixtures of these. The gluten-free starch-containing material comprised within the gluten-free biscuit of the invention may be selected from the group consisting of maize starch, corn meal, buckwheat flour, millet flour, amaranth flour, quinoa flour, potato starch, sweet potato flour, tapioca starch, rice starch, rice flour, sorghum flour, bean flour, pea flour, pea starch, soy flour, chickpea flour, cowpea flour, lentil flour, bambara bean flour, lupin flour, peanut flour, chestnut flour and combinations of these. For example the starch-containing material may be a mixture of corn starch, potato starch and white rice flour, which mixture provides particularly good texture, moisture retention and final biscuit quality. For a darker colour, the gluten-free starch-containing material may be a mixture of brown rice flour, potato starch, soy flour and/or lupin flour. The gluten-free starch-containing material may be a mixture of tapioca starch, potato starch and rice flour. The gluten-free starch-containing material of the gluten-free biscuit of the invention may comprise between 30 and 50 wt. % flour. For example the gluten-free starch-containing material may contain between 10 and 30 wt. % corn starch, between 30 and 50 wt. % potato starch and between 30 and 50 wt. % rice flour. The starch-containing material may comprise a flour which has been at least partially defatted.

Biscuits comprising whole grains present particular challenges as bran from the whole grain binds water making it less available in the dough structure and leading to problems of poor biscuit cohesion. The inventors were surprised to find that whole grain biscuits could be made with good cohesion using canola protein. The gluten-free starch-containing material comprised within the gluten-free biscuit of the invention may be a gluten-free whole grain flour.

The gluten-free biscuit of the invention may comprise a natural source of non-starch polysaccharides such as from fruit, vegetable, cereal, pseudocereal or legume source. Adding non-starch polysaccharides fibre ingredients improves the biscuit texture by providing the textural attributes that would be provided by wheat fibre in conventional wheat-based biscuit. For example the non-starch polysaccharides may be gluten-free cereal bran, beet fibre, fruit pectin or pea fibre. The gluten-free biscuit of the invention may provide a source of dietary fibre. According to Codex guidelines [Guidelines for use of nutritional and health claims CAC/GL 23-1997], to provide a source of dietary fibre a product should contain at least 3 g per 100 g of fibre. The gluten-free biscuit of the invention may contain at least 3 g of fibre per 100 g. Gluten free biscuits are often brittle as they lack the structural cohesion given by gluten proteins. Adding fibre tends to make this problem worse as the fibre binds water and reduces its ability to promote starch granule adhesion. It is therefore advantageous that the canola protein in the gluten-free biscuits of the invention allows the inclusion of high levels of fibre without the biscuits becoming unacceptably brittle. To further enhance the nutritional value of the biscuit, the gluten-free biscuit of the invention may also comprise iron, folic acid, and other B vitamins.

Pentosans (polysaccharides composed of pentoses) have the undesirable effect in biscuits of binding water and preventing the dough from spreading when desired, such as for a deposited biscuit (the machine-made counterpart of a hand-dropped biscuit). Preferably the gluten-free biscuit of the invention is low in pentosans, for example the ratio of starch to pentosans may be greater than 30:1.

The Brassicaceae seed protein comprised within the gluten-free biscuit of the invention may be obtained from seeds selected from the group consisting of Brassica napus, Brassica rapa, Brassica juncea, Brassica nigra, Brassica hirta and combinations of these. The Brassicaceae seed protein may for example be rapeseed or canola protein. Canola is the Canadian oilseed crop developed primarily for the purpose of edible oil. It was naturally bred to reduce erucic acid in the oil and glucosinolates in the meal. The plants are cultivars of either rapeseed (Brassica napus) or field mustard/turnip rape (Brassica rapa). Recent cross-breeding of multiples lines of Brassica juncea have enabled this mustard variety to also be classified as a Canola variety. Canola is defined as seeds of the genus Brassica (Brassica napus, Brassica rapa or Brassica juncea) from which the oil shall contain less than 2% erucic acid in its fatty acid profile and the solid component shall contain less than 30 micromoles of any one or any mixture of 3-butenyl glucosinolate, 4-pentenyl glucosinolate, 2-hydroxy-3 butenyl glucosinolate, and 2-hydroxy-4-pentenyl glucosinolate per gram of air-dry, oil-free solid. Canola protein forms aggregates (for example upon heating) which mimic the rheological characteristics of hydrated gluten proteins making Canola protein particularly suitable as a gluten replacer in biscuits.

The Brassicaceae seed protein comprised within the gluten-free biscuit of the invention may be in the form of a protein isolate or a protein concentrate. Concentrates are typically considered to be between 40-89 wt. % protein on a dry basis, while 90 wt. % protein and above is considered as protein isolate. Protein isolates may be obtained from defatted Brassicaceae seeds by a number of extraction and purification processes, such as extraction with alkaline solution, enzymatic extraction, methods involving the formation of a protein micellar mass, salting out the protein with NaCl or combinations of these processes. Methods for obtaining canola protein isolates are summarized by Tan [S. H. Tan et al., J Food Sci., 76, R16-R28 (2011)].

Non-starch hydrocolloids are often used in gluten-free biscuits, acting to stabilize the biscuit. However, use of these materials may lead to a brittle, crumbly final texture. In addition, consumers may prefer biscuits made from only a small number of familiar ingredients and so it is beneficial that by using Brassicaceae seed protein as a gluten replacer the addition of non-starch hydrocolloids may be avoided. The gluten-free biscuits of the invention may be free from agar-agar, carrageenan, gum Arabic, tragacanth, locust bean gum, guar gum, cellulose derivatives and xanthan gum. The gluten-free biscuits of the invention may be free from modified starch; that is starch prepared by enzymatically or chemically treating native starch, thereby altering its properties.

The gluten-free biscuits of the invention may comprise other proteins in addition to the Brassicaceae seed protein. For example, to provide a significant source of protein the gluten-free biscuits of the invention may comprise peanut, lupin or soy protein. The gluten-free biscuits of the invention may comprise soy protein in addition to the Brassicaceae seed protein, for example the gluten-free biscuits of the invention may comprise soy protein isolate.

Milk proteins and egg proteins are used in a number of gluten-free biscuit recipes. Milk proteins in particular are able to build up a network structure similar to gluten. Unfortunately, some consumers are allergic to milk or egg proteins, or chose not to eat them due to their animal origin, e.g. vegans. It is therefore beneficial that, by using Brassicaceae seed protein as a gluten replacer, an acceptable biscuit may be obtained without the use of milk or egg proteins. The gluten-free biscuit of the invention may be free from milk protein and egg protein.

The gluten-free biscuits of the invention may be free from oats. The Codex Alimentarius Standard 118-1979 on gluten-free foods states that oats can be tolerated by most but not all people who are intolerant to gluten. Oats contain avenin, which, like gluten is a prolamin protein. Although most people with coeliac disease can safely eat avenin, oats are frequently processed or grown near wheat, barley and other grain, so may contain gluten from these cereals. For this reason many consumers wishing to avoid gluten will also avoid products containing oats.

The gluten-free biscuit of the invention may be leavened (aerated). It may be leavened by a number of different processes. Common leaveners used in biscuits are baking powders and yeast. Air and water (steam) are also leaveners. They cause expansion of the product during baking, providing the dough or batter has a structure capable of retaining gas. In a conventional wheat flour biscuit, the gluten absorbs water and forms extensible membranes that trap gas and expand to decrease the density of the dough mass. Without correct leavening, most biscuit types will not have the appearance and eating qualities required by consumers, so it is beneficial that, by using Brassicaceae seed protein as a gluten replacer, acceptable leavened biscuits can be obtained.

The biscuits of the invention are not particularly limited by biscuit type. In general, biscuit formulas can be divided into different groups. Saltines and other fermented products use a sponge-and-dough system that is normally formulated with yeast. In contrast, straight cracker doughs and the like will have small amounts of sugar, fat and are chemically leavened. Sweet biscuit (cookie) formulas will contain moderate to high amounts of sugar and fat (“shortening”) and are primarily leavened with sodium bicarbonate and ammonium bicarbonate in combination with a leavening acid to produce biscuits with good volume. Sweet biscuits may contain other ingredients such as icings, fillings, fruits, nut pastes or pieces, flavours and chocolate. Wafers are made from wafer batter and have crisp, brittle and fragile consistency. They are thin, with an overall thickness usually between <1 and 4 mm and typical product densities range from 0.1 to 0.3 g/cm3. The surfaces are precisely formed, following the surface shape of the plates between which they were baked. They often carry a pattern on one surface or on both. Two basic types of wafer are described by K. F. Tiefenbacher in “Encyclopaedia of Food Science, Food Technology and Nutrition p 417-420—Academic Press Ltd London—1993”:
1) No- or low-sugar wafers. The finished biscuits contain from zero to a low percentage of sucrose or other sugars. Typical products are flat and hollow wafer sheets, moulded cones or fancy shapes.
2) High-sugar wafers. More than 10% of sucrose or other sugars are responsible for the plasticity of the freshly baked sheets. They can be formed into different shapes before sugar recrystallization occurs. Typical products are moulded and rolled sugar cones, rolled wafer sticks and deep-formed fancy shapes.

In general, sweet biscuit formulas are classified according to the type of equipment used to form the individual pieces. The type of equipment being used for a product sets limits on the dough rheological properties. The following three broad types of forming or shaping devices are used to manufacture the great majority of commercial sweet biscuits [Wiley Encyclopedia of Food Science and Technology, 2^{nd} Edition, Vol 1, p 187, 2000].
1. Extruders push the dough or batter through a constricting orifice; they are exemplified by deposit machines, bar presses and wire-cut equipment.
2. Rotary moulders shape the dough in die cavities cut into the surface of a metal cylinder.
3. Stamping machines or rotary cutters cut shaped pieces from a continuous sheet of dough.

The gluten-free biscuit of the invention may be a wire-cut, rotary molded, stamped or rotary cut biscuit, for example it may be a biscuit which is rotary moulded or cut out of a laminated sheet of dough. These types of biscuit require an elastic and cohesive dough which holds its shape before cooking, the elasticity and cohesion would traditionally be provided by gluten in wheat flour. The cohesiveness of the dough for these biscuits is in contrast to the mixture used for biscuits such as drop cookies or trail mix cookies which generally has a soft sticky consistency. Drop cookies and trail mix cookies are often made with no wheat flour; ingredients such as fats and sugar syrups are used to hold the mixture together. Egg may be added as a fat binder, but is not replacing the functionality of gluten as, in these cookies, gluten it is not essential.

The gluten-free biscuit of the invention may be a deposit or a wire-cut biscuit. Brassicaceae seed protein permits the creation of a biscuit dough with good spread during baking. Without wishing to be bound by theory, the inventors believe that the Brassicaceae seed protein starts to aggregate during the baking process and the water associated with the protein is released, thereby promoting spreading. This spreading is particularly useful for deposit biscuits and wire-cut biscuits. In contrast, other proteins such as egg denature too quickly during baking and stop the spread. For biscuits where spread is not required, for example sandwich biscuits, the spread can be controlled by correct choice of ingredients for example by changing the glass transition temperature of the mix by altering the carbohydrate blend or increasing water-binding ingredients. In these types of gluten-free biscuits, Brassicaceae seed protein still provides an advantage in providing correct structure creation during leavening and in reducing breakage in the final biscuit.

Brassicaceae seed protein in the gluten-free biscuit of the invention provides a biscuit with a good snap when broken. A snap is particularly important for wire-cut, rotary molded, stamped or rotary cut biscuits. As explained above, biscuits such as drop cookies and trail mix cookies do not traditionally rely on gluten functionality for their texture, and indeed these types of biscuits tend to have a soft crumbly texture rather than having a snap when broken.

The gluten-free biscuit of the invention may be comprised within a gluten-free food product. For example the gluten-free biscuit may be crumbled to form the base of a cheesecake.

The gluten-free biscuit of the invention may provide a source of protein. According to Codex guidelines [Guidelines for use of nutritional and health claims CAC/GL 23-1997], to provide a source of protein a product should provide 10% of nutrient reference value (NRV) per 100 g. The NRV for protein is 50 g, so a product providing 5 g protein per 100 g can be described as a source of protein. The gluten-free biscuit of the invention may contain at least 5 g per 100 g of protein, for example at least 10 g protein per 100 g.

In another aspect, the invention provides a process for manufacturing a gluten-free the process comprising preparing a gluten-free dough comprising between 4 to 30 wt. % water and, on a dry basis, 0.5 to 10 wt. % Brassicaceae seed protein, 15 to 75 wt. % starch, 1 to 40 wt. % sweetener and 0 to 40 wt. % oil and/or fat and cooking the dough, wherein the starch has a particle size distribution D90 less than 1000 μm (for example a D90 less than 300 μm) or is comprised within a starch-containing material having a particle size distribution D90 less than 1000 μm (for example a D90 less than 300 μm). The term gluten-free dough means that the dough contains less than 20 ppm gluten. For example, none of the components of the dough may comprise gluten. At least part of the Brassicaceae seed protein comprised within the gluten-free dough in the process of the invention may be in its native form, for example at least 20 wt. % of the Brassicaceae seed protein comprised within the gluten-free dough of the process of the invention may be in its native form. The dough may be cooked by baking or any other of the methods known for cooking biscuits such as frying. However, nearly all biscuits are cooked by baking.

For biscuits leavened with yeast, a proofing step may be introduced. Proofing (also called proving) is the final dough-rise step in a yeast-fermented dough before baking, and refers to a period when the biscuit is left to rise.

In a further aspect, the invention provides a gluten-free dough for making gluten-free biscuits, the dough comprising between 4 and 30 wt. % water and, on a dry basis, 0.5 to 10 wt. % Brassicaceae seed protein, 15 to 75 wt. % starch, 1 to 40 wt. % sweetener and 0 to 40 wt. % oil and/or fat, wherein the starch has a particle size distribution D90 less than 1000 μm or is comprised within a starch-containing material having a particle size distribution D90 less than 1000 μm.

Recent years have shown a growth in supermarkets and roadside service stations having small in-store bakeries which bake biscuits on the premises. Many of these in-store bakeries use ready-to-bake dough, so the employees of the bakery do not need to prepare the biscuit dough themselves. Pre-mixed biscuit dough is also available for consumers to purchase and bake biscuits conveniently at home. Such ready-to-bake dough may be chilled or frozen to prevent the growth of spoilage organisms. Chilled food is typically maintained at temperatures between 2 and 8° C. in storage and transit, while frozen food is typically maintained below −18° C. The gluten-free dough of the invention may be a chilled or frozen ready-to bake dough.

Ready-to-bake dough is generally provided in the form of a sufficiently solid or semi-solid block. The block is typically provided under refrigerated or frozen conditions, is purchased that way by the consumer, and then is removed from the refrigerator or freezer, thawed if necessary, and then is cut or separated into pieces that are then placed onto a pan or into a baking tin for baking into the final product. The block will typically be in a cylindrical (“chub pack”) or rectangular prism form, although many different shapes for the block are possible, as will be readily envisioned by those of ordinary skill in the art. The ready-to-bake dough is typically cut into smaller pieces, such as those that can be baked into individual biscuits. The consumer simply cuts a desired thickness of the dough from the block. To assist in providing optimal sizes, an imprint, marking or cut line can be provided on the body or upper surface of the block. In this way, individual baked items can be made. A knife is typically used to completely cut pieces from the block of dough.

The pieces are then placed on a pan or sheet and baked. There is no waste due to shaping, and no manipulation is required, other than cutting of the dough by the consumer prior to baking. The dough should be capable of flowing upon baking and the pieces may be baked on a sheet or pan that allows them to flow to form shaped, e. g., substantially round, baked products, if desired. As explained before, Brassicaceae seed protein permits the creation of a biscuit dough with good spread during baking.

Those skilled in the art will understand that they can freely combine all features of the present invention disclosed herein. In particular, features described for the products of the present invention may be combined with the process of the present invention and vice versa. Further, features described for different embodiments of the present invention may be combined. Where known equivalents exist to specific features, such equivalents are incorporated as if specifically referred to in this specification. Further advantages and features of the present invention are apparent from the figure and non-limiting examples.

### EXAMPLES

### Example 1: Sweet Biscuits Containing Canola Protein Isolate

Trials were carried out to evaluate the performance of canola protein isolate as a gluten replacer in gluten-free biscuits. Biscuits were produced following a simplified test baking procedure (ref. AACC 10-50.05). The formulations for the biscuits are presented in Table 1. In the gluten-free recipes, wheat flour was replaced by corn starch, potato starch, corn flour, and rice flour. Canola protein was added at a level of 5 or 10% on the flour basis. Canola protein isolate (Isolexx™—91.4% protein) was purchased from BioExx Specialty Proteins Ltd.

TABLE 1
Composition of gluten-free doughs using canola protein
(amounts in grams)

| | | Gluten-free recipe | Gluten-free recipe |
|---|---|---|---|
| Ingredients | Reference | 5% Canola protein | 10% Canola protein |
| Wheat flour | 71.4 | 0.0 | 0.0 |
| Starch or Flour | 0.0 | 68.0 | 64.0 |
| Canola protein | 0.0 | 3.8 | 7.5 |
| Sucrose | 41.3 | 41.3 | 41.3 |
| Salt | 0.7 | 0.7 | 0.7 |
| Butter | 20.3 | 20.3 | 20.3 |
| Sodium | 0.8 | 0.8 | 0.8 |
| bicarbonate | | | |
| Water | 15.6 | 15.6 | 15.6 |

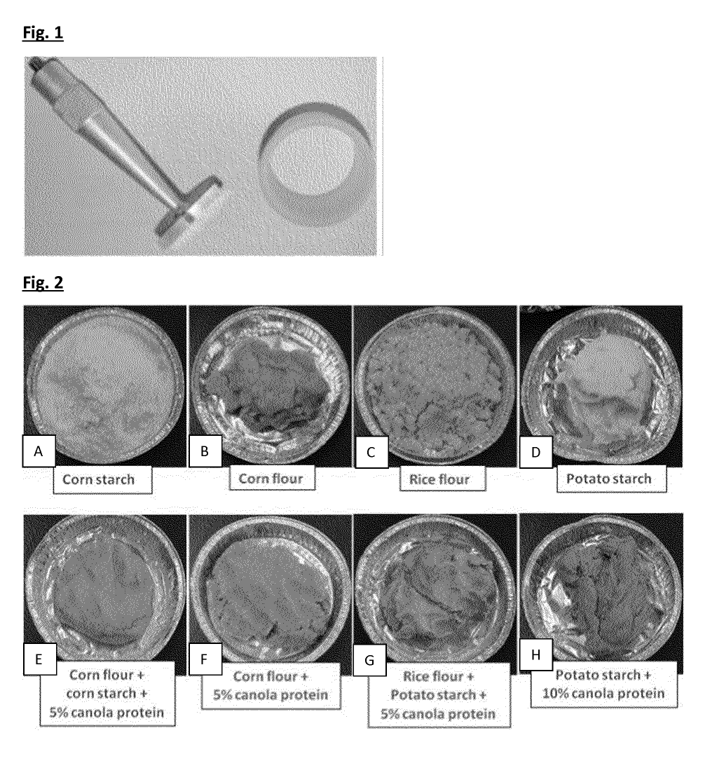

The dry ingredients were mixed during 3 min using a Hobart mixer, and then fat and water were added. The dough was mixed during 10 min or until it started to stick, and was subsequently (14 g) placed in a cylindrical mould (4.6 cm internal diameter, 3.5 cm height) (FIG. 1) and pushed with a piston (4.5 cm diameter) to obtain a circle of dough of 4.6 cm of diameter and approximately 0.5 cm of thickness. The biscuits were baked in a domestic oven, at an approximate temperature of 200° C. for 12 min. Once baked, the biscuits were allowed to cool for 30 min. The biscuits were stored in a plastic bag hermetically closed.

The doughs obtained showed different behaviours depending on the material (starch or flour source) used to produce them (FIG. 2). In general, the addition of canola protein enhanced the cohesiveness of dough prepared with corn starch, rice flour and corn flour. Potato starch produced sticky dough, but the stickiness was slightly reduced by adding canola protein. Independently of the raw material used, all the doughs obtained were appropriate to make biscuits using the biscuit moulder.

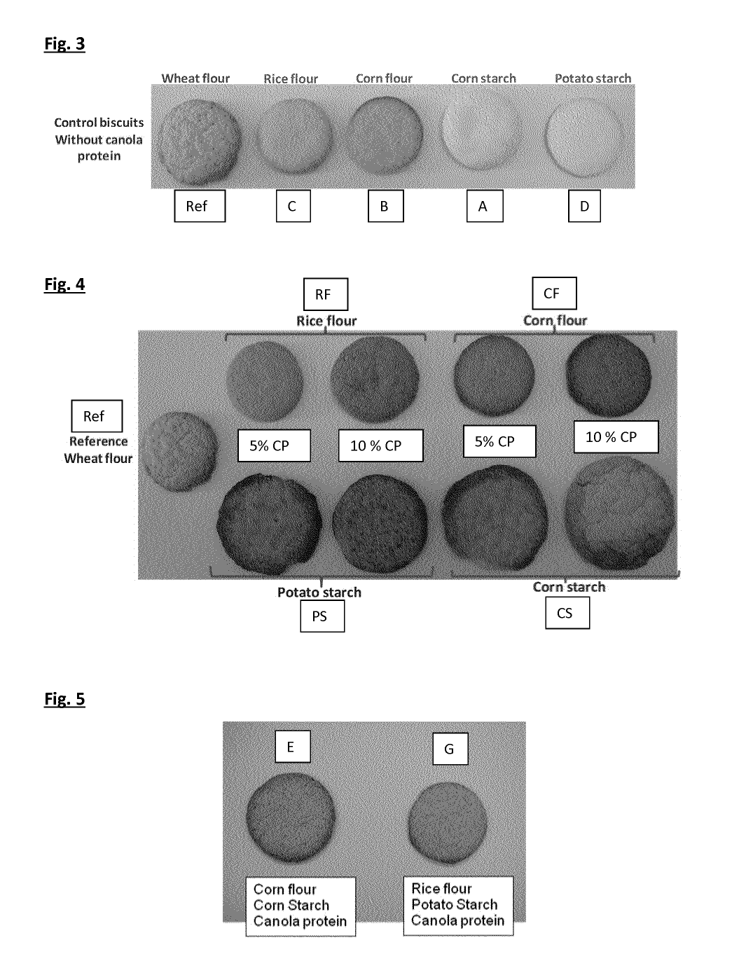

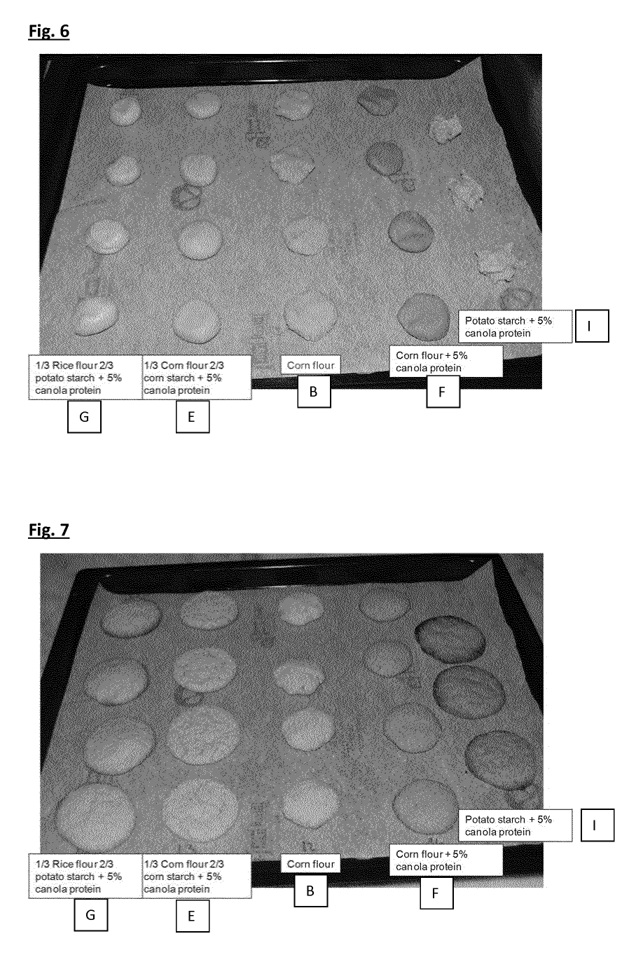

FIG. 3 shows control biscuits without canola protein and FIGS. 4 and 5 show the gluten-free biscuits obtained after baking. All the recipes were able to produce biscuits which showed different sensory characteristics, depending on the recipe used (canola content, starch and flour). The addition of canola protein increased the spreading of a biscuit during baking, therefore biscuits containing canola protein were larger (diameter) and thinner than control biscuits (without canola protein). This effect increased with content of canola protein.

Further baking trials have showed “forming properties” of canola protein, since dough directly placed in the oven without previous formatting, spreads to produce biscuits with a proper shape (FIG. 6 shows before baking and FIG. 7 shows after baking). These “forming properties” are advantageous for ready-to-bake doughs and for deposited biscuits which may not be evenly shaped before baking.

Technical tasting showed that different types of texture can be generated depending on the starch and flour used.

The processability and the sensory characteristics (texture and taste) were improved when biscuits were manufactured using a mix of canola, starch and cereal flour. In general, rice flour and potato starch in combination with canola protein were the ingredients that produced the best biscuits in terms of texture and taste.

### Example 2: Effect of Canola Protein on Texture

Two simple gluten free biscuit recipes, with (K) and without canola (J), were prepared.

TABLE 2
Composition of gluten-free doughs (amounts in grams)

| | J (negative control) | K (canola) |
|---|---|---|
| brown rice flour | 23.8 | 22.8 |
| potato starch | 23.8 | 22.8 |
| Canola protein isolate | | 2.0 |
| sugar | 27.5 | 27.5 |
| salt | 0.5 | 0.5 |
| butter | 13.5 | 13.5 |
| baking powder | 0.5 | 0.5 |
| water | 10.4 | 10.4 |

The dry ingredients were mixed for 3 min using a Hobart mixer, and then fat and water were added. The dough was mixed until it started to stick, and was subsequently laminated to 3 mm of thickness. During lamination, the lower cohesiveness of the negative control dough was evident. Doughs were cut with a 4 cm diameter mould and baked in the oven for 11 min at 170° C.

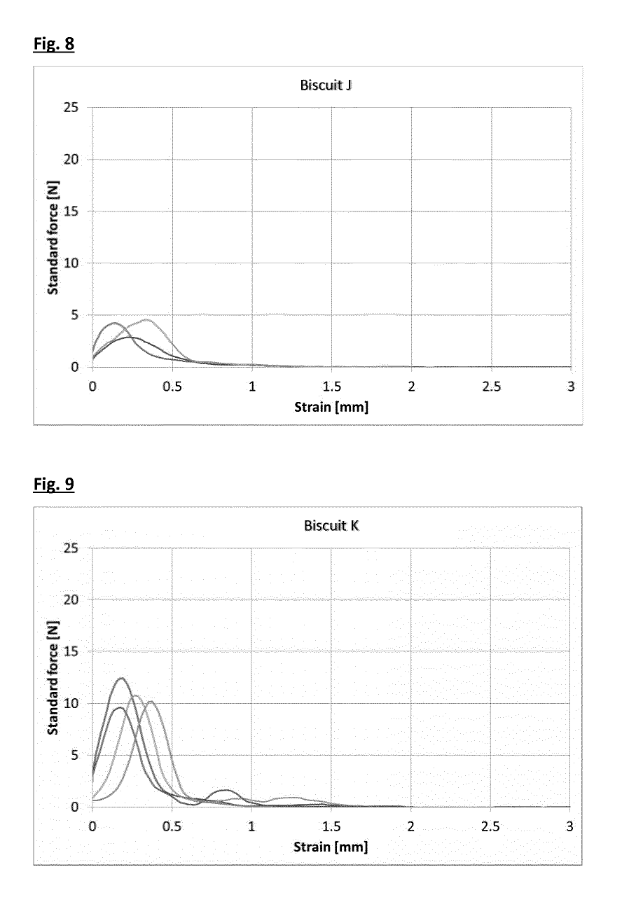

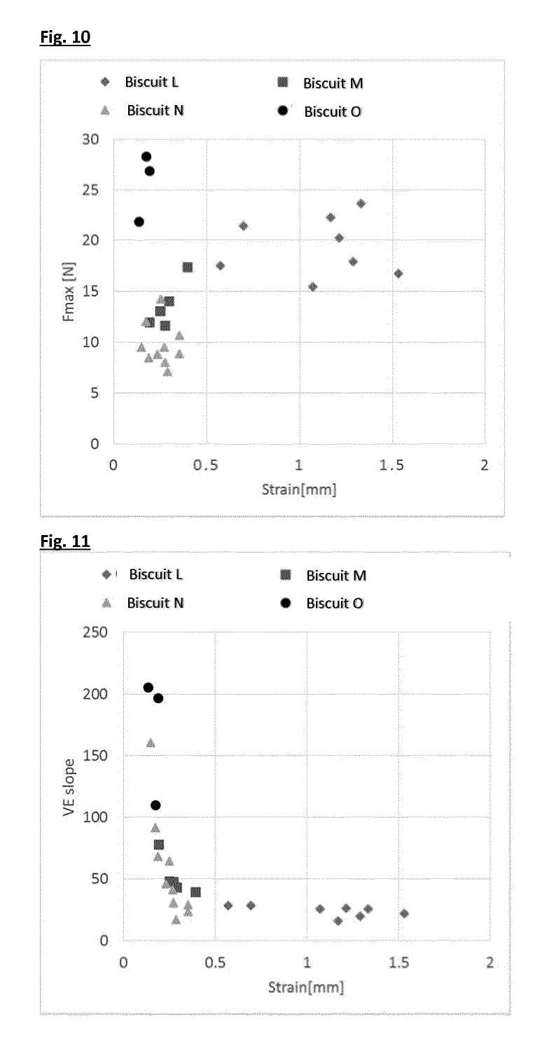

The texture of the two biscuits were compared using a texture analyzer. The biscuits were subjected to a three-point bending test. The texture analyzer used was a Zwick Roell Z005 equipped with a 5 kN captor. The cakes laid on two supports having a cylindrical profile of radius 1.5 mm and being 35 mm apart from each other. The measurements were performed at room temperature with a constant cross head speed of 2 mm/s. Plots of the measured standard force (N) against strain (mm) with repetitions are shown in FIGS. 8 and 9. The results showed that about twice as much force was required to break the canola-containing biscuit (K) compared to the negative control (J).

### Example 3: Comparison with Gluten-Containing Biscuits and Commercial Gluten-Free Biscuits

Four Biscuits were Compared:

(L) a commercial gluten-free biscuit “Gluten free biscuits sables from Damhert Nutrition” the ingredients including rice flour, potato starch and lupin.

(M) a commercial wheat based biscuit “Nesfit™ Leite e mel biscuit from Nestlé Brasil comprising wheat flour, whole grain wheat flour and starch.

(N) a gluten-free biscuit made according to the method of example 1 and comprising brown rice flour, lupin flour and potato starch as the starch-containing ingredients and 2.6% canola protein isolate on a dry basis.

(O) a gluten-containing biscuit made according to the method of example 1 and comprising wheat flour, whole grain wheat flour and starch but no canola protein.

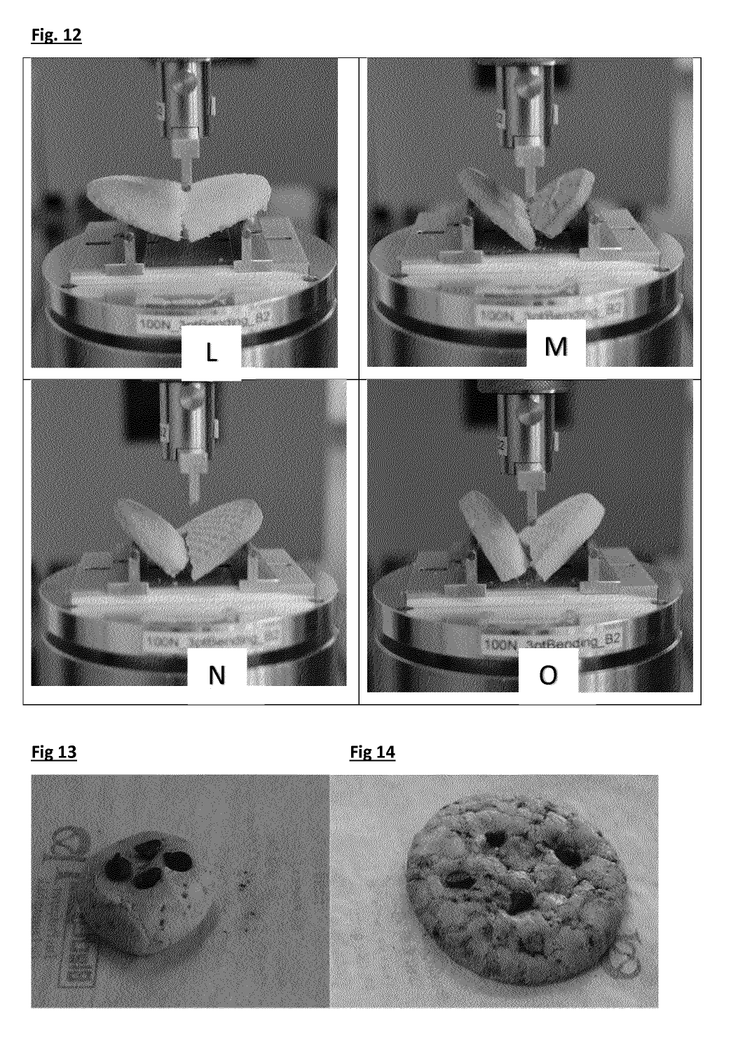

The texture of the biscuits was measured according to the method of example 2. Plots of the maximum force recorded versus the displacement at maximum force are shown in FIG. 10 while FIG. 11 shows the slope at the beginning of the force-strain curve (visco-elastic modulus) plotted against the displacement at the maximum force.

Although the gluten-free canola-containing biscuit made according to the method of example 1 (N) showed lower maximum force values than those of the gluten-containing biscuit made by the same method (O) it has comparable maximum force values to those of a commercial gluten-containing biscuit (M). The strain required to break these three types of biscuits was fairly similar, indicating that the biscuits have a similar “snap” when bent, although O requires the most force before it fractures (FIG. 10). On the other hand, the commercial gluten-free biscuits (L) showed more “stickiness”, bending much more before they broke, indicated by the larger strain values at maximum force. The commercial gluten-free biscuit (L) had lower visco-elastic moduli than the gluten-free biscuit with canola (N) and the two gluten-containing biscuits (M and O) (FIG. 11). It was noticeable that the two gluten-containing biscuits (M and O) and the gluten-free biscuit containing canola protein (N) broke cleanly into distinct pieces, whereas the pieces of the commercial gluten-free biscuit remained attached after breaking (see FIG. 12).

In simulated transport tests packed loose in a bag, the commercial gluten-free biscuits showed more breakage than the gluten-free biscuit with canola (N) and the two gluten-containing biscuits (M and O).

Thus the gluten-free biscuit made according to the invention was closer in textural attributes to the two wheat biscuits than to the commercial gluten-free biscuit.

### Example 4: Ready-to-Bake Biscuit Dough Containing Canola Protein Isolate

A gluten-free chocolate chip cookie ready-to-bake dough was made from the following ingredients.

TABLE 3
Composition of gluten-free dough (amounts in grams)

| | |
|---|---|
| brown rice flour | 21.6 |
| potato starch | 14.4 |
| canola protein isolate | 2.4 |
| sugar | 23.6 |
| baking powder | 0.6 |
| salt | 0.4 |
| vanilla sugar | 0.2 |
| Butter/margarine | 16.7 |
| chocolate chips | 15.2 |
| water | 4.9 |

The dry ingredients were mixed for 3 min using a Hobart mixer, and then fat and water were added. The dough was mixed until it started to stick. The dough was then formed into and block and chilled.

To test the dough it was removed from the refrigerator and cut into cube shaped portions. Each portion was decorated with further chocolate chips (FIG. 13). The dough portions were baked in a domestic oven, at an approximate temperature of 200° C. for 12 min. The canola-containing dough spread out to form neat circular biscuits (FIG. 14).

### Example 5: Gluten Free Biscuits Having Increased Protein and Fiber Contents

Gluten free biscuits having increased protein and fiber contents compared to typical commercial biscuit were prepared according to recipe below. The dry ingredients were mixed during 3 min using a Hobart mixer, and then fat and water were added. The dough was mixed until it started to stick, and was subsequently laminated to 3 mm of thickness, cut with the mould to 4 cm diameter and baked in the oven for 11 min at 170° C.

TABLE 4
Composition of gluten-free dough with increased protein and fibre
contents (amounts in grams)

| | |
|---|---|
| soy flour | 6.0 |
| lupin flour | 12.8 |
| Partially defatted peanut flour | 4.3 |
| potato starch | 20.4 |
| Canola protein isolate | 1.9 |
| sugar | 26.2 |
| salt | 0.4 |
| butter | 12.9 |
| baking powder | 0.5 |
| water | 14.7 |

On a dry basis the biscuits had a protein content of around 15 g/100 g and a fiber content 5.5 g/100 g. The biscuits had a good cohesive texture without being too brittle.

1. Gluten-free biscuit comprising between 0.5 and 15 wt. % Brassicaceae seed protein on a dry basis and a gluten-free starch-containing material having a particle size distribution D90 less than 1000 μm.

2. A gluten-free biscuit according to claim 1 comprising on a dry basis 0.5 to 10 wt. % Brassicaceae seed protein, 15 to 75 wt. % starch, 0 to 40 wt. % sweetener and 0 to 40 wt. % oil and/or fat.

3. A gluten-free biscuit according to claim 1 wherein the gluten-free starch-containing material is selected from the group consisting of maize starch, corn meal, buckwheat flour, millet flour, amaranth flour, quinoa flour, potato starch, sweet potato flour, tapioca starch, rice starch, rice flour, sorghum flour, bean flour, pea flour, pea starch, soy flour, chickpea flour, cowpea flour, lentil flour, bambara bean flour, lupin flour, peanut flour, chestnut flour and combinations of these.

4. A gluten-free biscuit according to claim 1 wherein the Brassicaceae seed protein is obtained from seeds selected from the group consisting of Brassica napus, Brassica rapa, Brassica juncea, Brassica nigra, Brassica hirta and combinations of these.

5. A gluten-free biscuit according to claim 1 wherein the Brassicaceae seed protein is rapeseed or canola protein.

6. A gluten-free biscuit according to claim 1 wherein the Brassicaceae seed protein is in the form of a protein isolate or a protein concentrate.

7. A gluten-free biscuit according to claim 1 which is free from agar-agar, carrageenan, gum Arabic, tragacanth, locust bean gum, guar gum, cellulose derivatives and xanthan gum.

8. A gluten-free biscuit according to claim 1 which is free from milk protein and egg protein.

9. A gluten-free biscuit according to claim 1 which is free from oats.

10. A gluten-free biscuit according to claim 1 which is a deposit or wire-cut biscuit.

11. A gluten-free biscuit according to claim 1 which contains at least 3 g of fibre per 100 g.

12. A gluten-free biscuit according to claim 1 which contains at least 5 g protein per 100 g.

13. Process for manufacturing a gluten-free biscuit, the process comprising:
preparing a gluten-free dough comprising between 4 to 30 wt. % water and, on a dry basis, 0.5 to 10 wt. % Brassicaceae seed protein, 15 to 75 wt. % starch, 1 to 40 wt. % sweetener and 0 to 40 wt. % oil and/or fat; and
cooking the dough,
wherein the starch has a particle size distribution D90 less than 1000 μm or is comprised within a starch-containing material having a particle size distribution D90 less than 1000 μm.

14. Gluten-free biscuit dough for making gluten-free biscuits, the dough comprising between 4 and 30 wt. % water and, on a dry basis, 0.5 to 10 wt. % Brassicaceae seed protein, 15 to 75 wt. % starch, 1 to 40 wt. % sweetener and 0 to 40 wt. % oil and/or fat, wherein the starch has a particle size distribution D90 less than 1000 μm or is comprised within a starch-containing material having a particle size distribution D90 less than 1000 μm.

15. Gluten-free dough according to claim 14 wherein the dough is a chilled or frozen ready-to bake dough.
